(19) United States
(12) Patent Application Publication
(10) Pub. No.: US 2026/0149958 A1
(43) Pub. Date: May 28, 2026

(54) RELEASE OF INCIDENT SCENE INFORMATION

(71) Applicant: MOTOROLA SOLUTIONS, INC., Chicago, IL (US)

(72) Inventors: Khairul Azhar Abu Bakar, Kepala Batas (MY); Mohammad Jazly, Teluk Intan (MY); Choo Enn Tay, Bagan Serai (MY); Sarawit AL Thanat, Sik (MY)

(21) Appl. No.: 18/958,874

(22) Filed: Nov. 25, 2024

(51) Int. Cl. H04W 4/90; H04W 68/00

(52) U.S. Cl. CPC H04W 4/90; H04W 68/005

(57) ABSTRACT

Examples provide systems and methods for releasing incident information. One example provides a system comprising a server including an electronic processor and a memory storing a machine learning model. The electronic processor is configured to receive characteristic data associated with a scene of interest and determine an incident value. The electronic processor is configured to provide, in response to the incident value being greater than or equal to a threshold, the characteristic data to the machine learning model, and receive, from the machine learning model, incident content based on the characteristic data and a recommendation indicating whether to provide the incident content to a public device. The electronic processor is configured to transmit the recommendation to a mobile device, receive an input indicating whether to provide the incident content to the public device, and transmit the characteristic data to the public device.

### BACKGROUND

During public safety and similar incidents, timely and effective communication between law enforcement (or other first responders) and the public is important to help ensure safety and coordinated response efforts. During public safety incidents, individuals in the vicinity of the incident may provide updates, including both image, video, and text description of the incident, on social media.

### BRIEF DESCRIPTION OF THE DRAWINGS

FIG. 1 illustrates a diagram of a communication system, according to some aspects.

FIG. 2 illustrates a block diagram of a communication device included in the communication system of FIG. 1, according to some aspects.

FIG. 3 illustrates a block diagram of a server included in the communication system of FIG. 1, according to some aspects.

FIG. 4 illustrates a flowchart of a method for determining whether to release information associated with a public safety incident in accordance with some examples.

FIG. 5 illustrates an informative characteristic table providing characteristics associated with different public safety incidents in accordance with some examples.

FIG. 6 illustrates a flowchart of a method for providing a risk analysis of information associated with a public safety incident in accordance with some examples.

FIG. 7 illustrates a flowchart of a method for providing incident information to the public in accordance with some examples.

FIG. 8 illustrates a flow chart of a method for determining whether to release information associated with a public safety incident in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments, examples, aspects, and features.

The apparatus and method components have been represented where appropriate by conventional symbols in the drawings, showing only those specific details that are pertinent to understanding the embodiments, examples, aspects, and features described and illustrated so as not to obscure the disclosure with details that will be readily apparent to those of ordinary skill in

the art having the benefit of the description herein.

### DETAILED DESCRIPTION

During public safety incidents (for example, shootings, terrorist events, fires, and other incidents where public safety is at risk), communication between law enforcement and the public can help to ensure safety and coordinated response efforts. Currently, when public safety incidents occur, individuals in the vicinity of the incident, and particularly those situated outside an immediate range of sight and communication with public safety officers, face challenges in receiving prompt updates and instructions from public safety officers. This lack of timely communication may result in confusion, frustration, and a perceived delay in response time, despite that public safety officers may already be actively monitoring and addressing the situation through their own communication channels.

Additionally, when communication between public safety officers and the public is delayed or missing, members of the public may begin posting information related to the incident on social media. These social media posts may include information that is incorrect, incomplete, or both, further hindering the relationship between the public safety officers and members of the public in the vicinity of the incident.

Thus, there is a need for, among other things, an enhanced communication mechanism that bridges the informational gap between public safety officers and individuals in the vicinity of the incident in real-time.

One example provides a system including a server including an electronic processor, a transceiver, and a memory, the memory storing a machine learning model. The electronic processor is configured to receive characteristic data associated with a scene of interest, determine an incident value indicative of whether the scene of interest is an active scene of interest, and provide, in response to the incident value being greater than or equal to a threshold,

the characteristic data to the machine learning model. The electronic processor is configured to receive, from the machine learning model, incident content based on the characteristic data and a recommendation indicating whether to provide the incident content to a public device, transmit, with the transceiver, the recommendation to a mobile device, where the recommendation is provided via an output device of the mobile device, receive, with the transceiver and from the mobile device, an input indicating whether to provide the incident content to the public device, and transmit, with the transceiver, the characteristic data to the public device.

In some aspects, the characteristic data includes an indication of whether the characteristic data is stored within a computer-aided dispatch (CAD) server.

In some aspects, the characteristic data includes social media posts associated with the scene of interest.

In some aspects, the machine learning model is configured to analyze keywords included within the social media posts associated with the characteristic data and generate the incident content based on the keywords included within the social media posts.

In some aspects, the characteristic data includes a video stream associated with the scene of interest. To determine the incident value, the electronic processor is configured to determine, based on the video stream, a number of people located at the scene of interest.

In some aspects, the electronic processor is further configured to update the machine learning model based on the input indicating whether to provide the incident content to the public device.

In some aspects, the output device is a display device having a graphical user interface, and the input indicating whether to provide the incident content to the public device is a touch input received by the graphical user interface.

In some aspects, the output device is a speaker, the input indicating whether to provide the incident content to the public device is a verbal input received by a microphone of the mobile device.

In some aspects, the mobile device includes an electronic digital assistant, where the electronic digital assistant provides the recommendation via the speaker, and the electronic digital assistant receives the verbal input via the microphone.

In some aspects, the recommendation indicating whether to provide the incident content to a public device includes an impact notification indicating an impact of whether the incident content is released to the public device.

In some aspects, to determine the incident value indicating whether the scene of interest is the active scene of interest, the electronic processor is configured to determine whether the scene of interest is associated with a predetermined period of time.

Another example provides a method for releasing incident information. The method includes receiving characteristic data associated with a scene of interest, determining an incident value indicative of whether the scene of interest is an active scene of interest and providing, in response to the incident value being greater than or equal to a threshold, the characteristic data to a machine learning model. The method includes receiving, from the machine learning model, incident content based on the characteristic data and a recommendation indicating whether to provide the incident content to a public device, transmitting, with a transceiver, the recommendation to a mobile device, where the recommendation is provided via an output device of the mobile device, receiving, with the transceiver and from the mobile device, an input indicating whether to provide the incident content to the public device, and transmitting, with the transceiver, the characteristic data to the public device.

In some aspects, the characteristic data includes an indication of whether the characteristic data is stored within a computer-aided dispatch (CAD) server.

In some aspects, the characteristic data includes social media posts associated with the scene of interest.

In some aspects, the method includes analyzing, with the machine learning model, keywords included within the social media posts associated with the characteristic data, and generating, with the machine learning model, the incident content based on the keywords included within the social media posts.

In some aspects, the characteristic data includes a video stream associated with the scene of interest, and determining the incident value includes determining, based on the video stream, a number of people located at the scene of interest.

In some aspects, the method includes updating the machine learning model based on the input indicating whether to provide the incident content to the public device.

In some aspects, the output device is a display device having a graphical user interface, and the input indicating whether to provide the incident content to the public device is a touch input received by the graphical user interface.

In some aspects, the output device is a speaker, and the input indicating whether to provide the incident content to the public device is a verbal input received by a microphone of the mobile device.

In some aspects, the mobile device includes an electronic digital assistant, wherein the electronic digital assistant provides the recommendation via the speaker, and the electronic digital assistant receives the verbal input via the microphone.

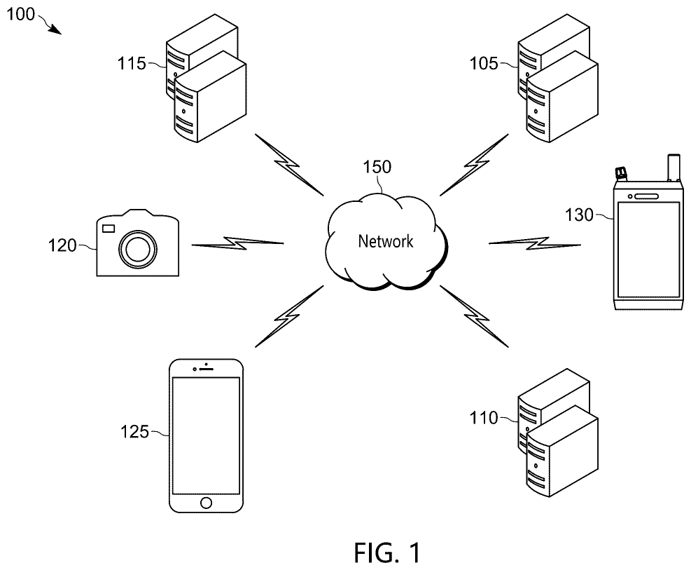

FIG. 1 is a diagram of a communication system 100 according to one example. In the example of FIG. 1, the communication system 100 includes a verification and analysis server 105, a social media server 110, a dispatch server (e.g., a computer-aided dispatch [CAD] server) 115, a camera 120, a mobile device 125, and a communication device 130 communicatively connected over a network 150. In some examples, the communication system 100 may include more or fewer devices than those shown in the communication system 100 illustrated in FIG. 1. For example, the communication system 100 may include multiple cameras 120, multiple mobile devices 125, multiple communication devices 130, or various combinations thereof.

Parts of the network 150 may be wireless and parts of the network 150 may be wired. All or parts of the network 150 may be implemented using various existing networks, for example, a cellular network, a Long Term Evolution (LTE) network, a 3GPP compliant network, a 5G network, the Internet, a land mobile radio (LMR) network, a Bluetooth™ network, a wireless local area network (for example, Wi-Fi), a wireless accessory Personal Area Network (PAN), a Machine-to-machine (M2M) autonomous network, and a public switched telephone network. The network 150 may also include future developed networks. In some embodiments, the network 150 may also include a combination of the networks mentioned previously herein.

In some examples, the social media server 110 is a server that hosts one or more social media platforms (for example, Facebook™, Instagram™, and the like). The social media server 110 may store a variety of posts provided on social media platforms, including text posts, image posts, video posts, and the like. In other examples, the social media server 110 is a server that stores an algorithm for obtaining information posted on social media platforms. For example, the social media server 110 may parse through social media platforms to identify key words and content associated with posts, identify post content associated with a given incident, identify a number of posts associated with a given incident, and the like, as described below in more detail. The social media server 110 may identify relevant social media posts based on location information associated with the posts, indicators (for example, hashtags) associating the social media post with the public safety event, or the like.

The dispatch server 115 (e.g., a CAD server) may be a server that stores information related to previous and active incidents. For example, the dispatch server 115 may store an interest time frame (e.g., dates during which the incident was active) associated with each incident stored in the dispatch server 115.

The camera 120 may be, for example, a video camera arranged to record an incident scene, for example a security camera, a camera associated with a news reporting station, a camera operated by a member of the public in the vicinity of the incident scene, and the like. The mobile device 125 may be a mobile computing device (e.g., a cell phone, a smart phone, a tablet computer, a laptop computer, a personal digital assistant (PDA), etc.), a desktop computing device, a server computing device, or other networked computing device. The communication device 130 may be some other communication device, for example a radio associated with a public safety officer, for example a two-way radio, a land mobile radio, or the like. While the example communication system 100 of FIG. 1 illustrates a variety of devices, the communication system 100 may also include other devices not explicitly illustrates, for example Internet-of-Things (IoT) smart devices, body-worn cameras, and the like.

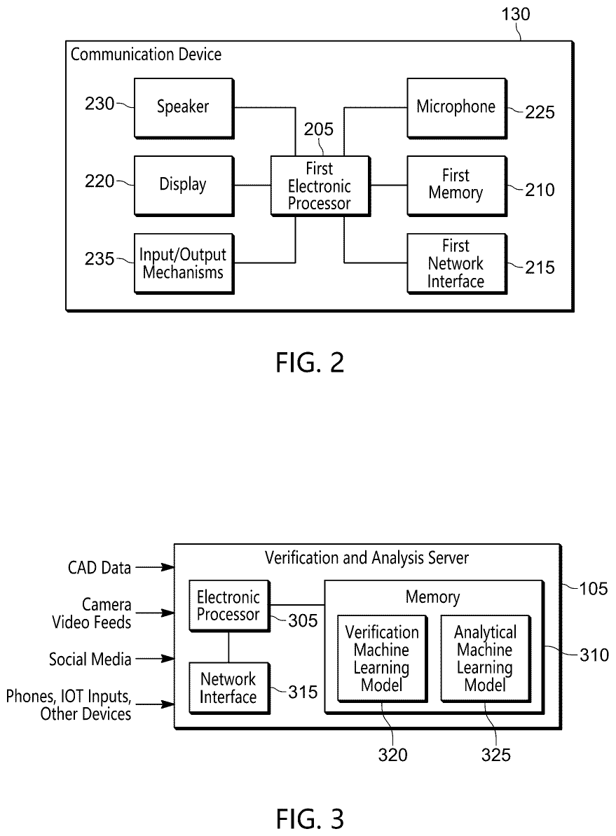

FIG. 2 is a block diagram of a communication device 130 of the communication system 100 according to one example. In the example shown, the communication device 130 includes a first electronic processor 205 (for example, a microprocessor or another electronic device). The first electronic processor 205 may be electrically connected to a first memory 210, a first network interface 215, a display 220, a microphone 225, a speaker 230, and other input and output mechanisms 235. In some embodiments, the communication device 130 may include fewer or additional components in configurations different from that illustrated in FIG. 2. For example, in some embodiments, the communication device 130 also includes a camera and a location component (for example, a global positioning system receiver). In some embodiments, the communication device 130 performs additional functionality than the functionality described below.

The first memory 210 includes read only memory (ROM), random access memory (RAM), other non-transitory computer-readable media, or a combination thereof that may include instructions and data. The first electronic processor 205 is configured to receive data from the first memory 210 and execute, among other things, the instructions. In some examples, the first electronic processor 205 executes instructions stored in the first memory 210 to perform the methods described herein. In some examples, the first memory 210 stores an electronic digital assistant (sometimes referenced as a “virtual partner”). The electronic digital assistant, when implemented by the first electronic processor 205, may provide a user of the communication device 130 with information in an automated (for example, without further user input) or semi-automated (for example, with some further user input) fashion. The information provided to the user may be based on explicit requests for information posed by the user via an input (for example, a parsed natural language input or an electronic touch interface manipulation associated with an explicit request) in which the electronic digital assistant may reactively provide requested information, or may be based on some other set of one or more context or triggers in which the electronic digital assistant may proactively provide valuable information to the user absent any explicit request from the user.

The first network interface 215 sends and receives data to and from the network 150. For example, the first network interface 215 may include a transceiver for wirelessly communicating with the network 150. Alternatively or in addition, the first network interface 215 may include a connector or port to establish a wired connection to the network 150. The wired connection may be created, for example, via an Ethernet cable. The first electronic processor 205 receives electrical signals representing sound from the microphone 225 and may communicate information related to the electrical signals over the network 150 through the first network interface 215. The information may be intended for receipt by another device, for example the mobile device 125. Similarly, the first electronic processor 205 may output data received from the network 150 through the first network interface 215, for example, as from the verification and analysis server 105, through the speaker 230, the display 220, or a combination thereof. For example, incident information and an associated impact may be provided via the speaker 230, the display 220, or a combination thereof.

FIG. 3 is a block diagram of the verification and analysis server 105 according to one example. In the example illustrated, the verification and analysis server 105 includes a second electronic processor 305 (for example, a microprocessor or another electronic device). The second electronic processor 305 may be electrically connected to a second memory 310 and a second network interface 315. In some instances, the verification and analysis server 105 may include fewer or additional components in configurations different from that illustrated in FIG. 3. In some instances, the verification and analysis server 105 performs additional functionality than the functionality described below.

The second memory 310 includes read only memory (ROM), random access memory (RAM), other non-transitory computer-readable media, or a combination thereof. The second electronic processor 305 is configured to receive data from the second memory 310 and execute, among other things, instructions stored in the second memory. In some instances, the second electronic processor 305 executes instructions stored in the second memory 310 to perform methods described herein.

The second memory 310 may also store a verification machine learning model 320 and an analytical machine learning model 325. The verification machine learning model 320 and the analytical machine learning model 325 may be, for example, a deep neural network (DNN), a convolutional neural network (CNN), a support vector machine (SVM), a regression algorithm, a large language model (LLM), or some other suitable machine learning model capable of performing operations described herein. The verification machine learning model 320 may be trained to receive a plurality of textual, image, and/or video inputs (for example, social media posts from the social media server 110) and identify informative keywords and conversational analytics associated with the plurality of inputs. An output of the verification machine learning model 320 may assist in verifying information associated with an incident scene, as described below in more detail. The analytical machine learning model 325 may be trained to receive the informative keywords and conversational analytics from the verification machine learning model 320 and determine whether to release information associated with the incident scene, as described below in more detail.

The second network interface 315 sends and receives data to and from the network 150. For example, the second network interface 315 may include a transceiver for wirelessly communicating with the network 150. Alternatively or in addition, the second network interface 315 may include a connector or port to establish a wired connection to the network 150. The wired connection may be created, for example, via an Ethernet cable. The verification and analysis server 105 receives various inputs from other devices within the communication system 100 via the second network interface 315, including, but not limited to, CAD data (e.g., data associated with incidents stored by the dispatch server 115) from the dispatch server 115, camera output from the camera 120, social media information from the social media server 110, and other inputs from devices for example the mobile device 125, the communication device 130, and the like.

While the verification and analysis server 105 is described as being a single server, in some implementations, the operations of the verification and analysis server 105 may be split between two or more servers. For example, a first server may include the verification machine

learning model 320 and perform a portion of the operations described herein, while a second server may include the analytical machine learning model 325 and perform another portion of the operations described herein.

The verification and analysis server 105 receives information associated with incident events and determines whether to release the information, or a portion of the information, to the public. For example, the verification and analysis server 105 analyzes camera video feeds (for example, video streams) to identify a number of people located at or near the incident scene, monitors social media posts, receives body-worn camera video feeds, and the like to identify informative keywords and conversations being spread by the public in the vicinity of the incident scene. The informative keywords and conversations may contradict the reality of how public safety officials are handling the information. Accordingly, the verification and analysis server 105 may recommend the release of information (or portions of the information) to the public based on a determined impact of said release. For example, a machine learning model may identify information related to the incident scene that would result in clarification of false information being spread through the public. A public safety officer may provide an input to approve the release of the information.

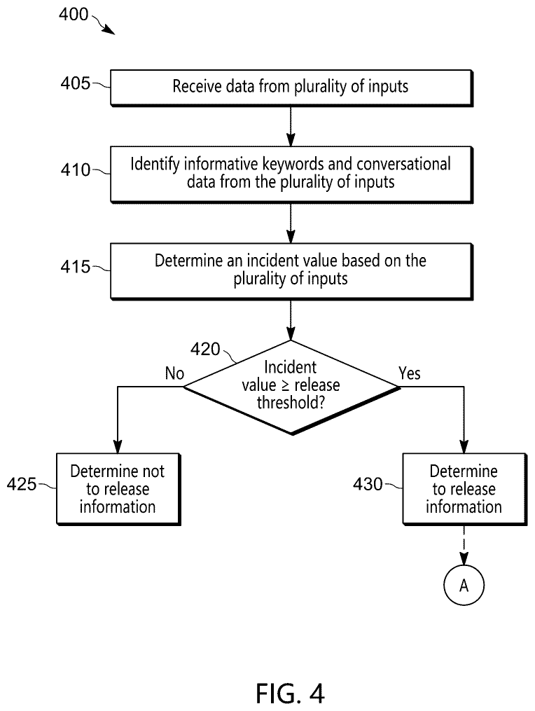

FIG. 4 illustrates an example method 400 for determining whether to release information associated with a public safety incident. The method 400 is described as being executed by the server 105 and, in particular, by the second electronic processor 305. However, in some instances, the method 400 may be performed by another device (for example, another computer or device within the communication system 100) or in conjunction with another device. Additionally, while the process blocks illustrated in FIG. 4 provide one example of a method described herein, it is understood that some blocks may be removed, added, combined, reordered, or modified without departing from the spirit of the present disclosure. The method 400 may occur with respect to a particular public safety incident (e.g., a scene of interest). The public safety incident may be an ongoing public safety incident or a public safety incident selected by a user of the communication device 130 or the verification and analysis server 105.

At block 405, the second electronic processor 305 receives data from a plurality of inputs. For example, the second electronic processor 305 receives CAD data associated with the public safety incident from the dispatch server 115. The CAD data may indicate whether the public safety incident is an active (e.g., ongoing) public safety incident, and/or may indicate a period of time (e.g., a time frame, a date, a time, etc.) during which the public safety incident was an active public safety incident. In some instances, the CAD data may indicate whether the public safety incident is an “outdated” public safety incident. A public safety incident may be indicated as outdated when the public safety incident occurred before a time threshold, for example an interest time frame, an indicated date, or the like. In some instances, the CAD data indicates whether information associated with the public safety incident is stored within the dispatch server 115. For example, the CAD data may indicate whether a case file exists for the public safety incident.

In some instances, when receiving data from the plurality of inputs, the second electronic processor 305 receives video feeds from one or more cameras (e.g., the camera 120, the mobile device 125, the communication device 130, etc.). The second electronic processor 305 may identify fields of views of people at the public safety incident, a number of people (e.g., a number of public safety officers, a number of the public, or a combination thereof) present at the public safety incident, or the like by analyzing the video feeds (for example, using a video analytic software).

When receiving data from the plurality of inputs, the second electronic processor 305 may also receive social media information from the social media server 110. For example, the second electronic processor 305 may receive social media posts themselves, a summary of content included in social media posts, a number of social media posts, and the like that are associated with the public safety incident. The second electronic processor 305 may also receive other inputs, for example from IoT devices at the incident scene.

At block 410, the second electronic processor 305 identifies informative keywords and conversational data from the plurality of inputs. As one example, second electronic processor 305 may analyze the video feeds provided by the one or more cameras to identify speech or writing associated with the incident scene. The verification machine learning model 320 may receive the video feeds as an input from the second electronic processor 305 and determine key words being said or written by members of the public within the video feeds. The keywords and conversational data are output by the verification machine learning model 320 and provided to the verification and analysis server 105. As another example, the verification machine learning model 320 receives the social media information as an input from the second electronic processor 305 and determines key words and conversational information being posted within relevant social media posts.

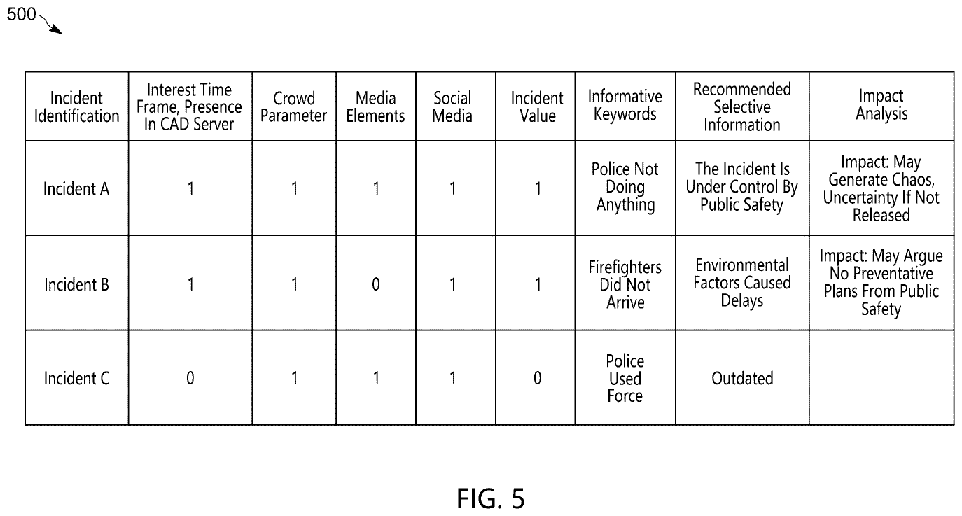

At block 415, the second electronic processor 305 determines an incident value based on the plurality of inputs. For example, FIG. 5 illustrates an example informative characteristic table 500 providing characteristics associated with different public safety incidents. The informative characteristic table 500 represents information analyzed by the second electronic

processor 305 and determinations performed by the informative characteristic table 500. While the second electronic processor 305 may generate (e.g., construct) the informative characteristic table 500, in other instances, the informative characteristic table 500 is not directly generated, and merely represents processing performed by the second electronic processor 305.

The informative characteristic table 500 provides an interest time frame (e.g., presence in the dispatch server 115), a crowd parameter, media elements, social media monitoring, an incident value, informative keywords, recommended selective information, and an impact analysis associated with example public safety incidents. In the example informative characteristic table 500 of FIG. 5, each column provides a binary value indicating the presence of the noted characteristic, where a “1” indicates the characteristic is present and a “0” indicates the characteristic is not present.

For example, with reference to Incident A, the interest time frame column stores a “1”, indicating that the incident A is an active (or ongoing) public safety incident. The second electronic processor 305 may determine whether the incident A is an active public safety incident based on the CAD data provided by the dispatch server 115. The crowd parameter column stores a “1”, indicating that a number of the public located at the public safety incident exceeds a crowd threshold. The number of public located at the public safety incident may be determined by the second electronic processor 305 based on, for example, an output of a video analytics software analyzing input video feeds, a number of social media posts provided by devices at the public safety incident, a number of devices at the public safety incident, and the like.

With continued reference to Incident A, the media element column stores a “1”, indicating that one or more cameras 120, one or more mobile devices 125, and/or one or more communication devices 130 are present at the public safety incident. The social media column also stores a “1”, indicating that a number of social media posts associated with the public safety incident exceed a social media threshold. The number of social media posts may be determined by the second electronic processor 305 based on the social media information provided by the social media server 110.

The second electronic processor 305 sets the incident value (in the incident value column) based on the values stored within the interest time frame column, the crowd parameter column, the media element column, and the social media column. The incident value may indicate a relevance of the public safety incident. For example, when all of the characteristics store a “1”, the second electronic processor 305 sets the incident value to “1”. In some examples, the incident value is set to “1” even if one or more of the characteristics are “0” (e.g., not present). For example, with respect to Incident B, the media elements column is set to “0”, indicating that media elements are not present. However, as the Incident B still is an active public safety incident, has a large crowd, and has ongoing relevant social media posts, the second electronic processor 305 still sets the incident value to “1”.

In some instances, when the public safety incident is not an active public safety incident, the incident value is set to “0”. For example, with respect to Incident C, the interest time frame column is set to “0”, indicating that the Incident C is not an active public safety incident. In response, the second electronic processor 305 sets the incident value to “1”.

In some instances, the characteristics may be averaged. If an average of the characteristics exceeds a threshold, the incident value is set to “1”. If the average of the characteristics is below the threshold, the incident value is set to “0”. For example, consider a threshold of 0.5 with respect to Incident B. The average of the characteristics in Incident B is (1+1+0+1)/4=0.75, which is greater than 0.5. In response, the second electronic processor 305 sets the incident value to 1.

The informative characteristic table 500 also provides informative keywords identified by the verification machine learning model 320 associated with each incident. The informative keywords may provide a summary of social media posts provided by the social media server 110. The informative keywords may be true or false, as described below in greater detail. Additionally, the “1”s and “0”s illustrated in FIG. 5 are merely examples, and other values, including non-binary values, may also be implemented indicating a presence of each characteristic.

Returning to FIG. 4, at block 420 the second electronic processor 305 compares the incident value to a release threshold. In response to the incident value being less the release threshold (for example, is set to “0”), the second electronic processor 305 proceeds to block 425. In response to the incident value being greater than or equal to the release threshold (for example, is set to “1”), the second electronic processor 305 proceeds to block 430. At block 425, the second electronic processor 305 determines not to release information related to the public safety incident.

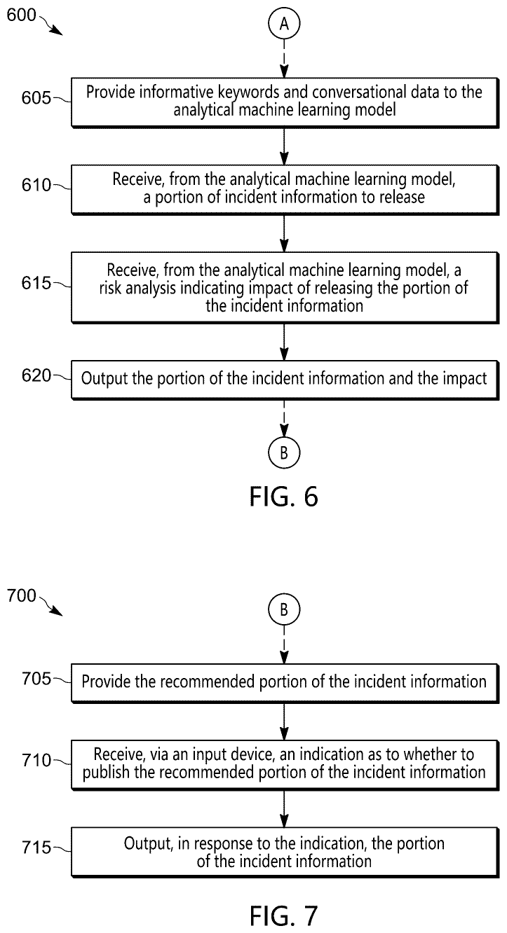

At block 430, the second electronic processor 305 determines to release information related to the public safety incident. In some implementations, the method 400 proceeds to block 605 of FIG. 6.

FIG. 6 illustrates an example method 600 for providing a risk analysis of information associated with a public safety incident. The method 600 is described as being executed by the server 105 and, in particular, by the second electronic processor 305. However, in some instances, the method 600 may be performed by another device (for example, another computer or device within the communication system 100). Additionally, while the process blocks illustrated in FIG. 6 provide one example of a method described herein, it is understood that some blocks may be removed, added, combined, reordered, or modified without departing from the spirit of the present disclosure. The method 600 may occur with respect to a particular public safety incident (e.g., a scene of interest). The public safety incident may be an ongoing public safety incident or a public safety incident selected by a user of the second electronic processor 305. In some implementations, the method 600 is a continuation of the method 400 of FIG. 4.

At block 605, the second electronic processor 305 provides the informative keywords and conversational data to the analytical machine learning model 325. For example, the second electronic processor 305 receives the informative keywords and conversational data from the verification machine learning model 320 indicative of content being shared on social media that is associated with the public safety incident.

At block 610, the second electronic processor 305 receives, from the analytical machine learning model 325, a portion of incident information to release. In some instances, the portion of incident information to release is a summary of what is occurring within the public safety incident, actions being taken by public safety officers at the public safety incident, clarifications on rumors or misinformation being spread related to the public safety incident, or the like. In some instances, the portion of incident information is a prepared news article describing the public safety incident.

In some implementations, the analytical machine learning model 325 determines that the informative keywords and conversational data provided by the verification machine learning model 320 include false or misleading statements. The analytical machine learning model 325 may generate incident information to release that clarifies or corrects the informative keywords and conversational data. As one example, the informative keywords and conversational data provided by the verification machine learning model 320 includes statements that a suspect at the public safety incident is innocent. The analytical machine learning model 325 may identify a known or confirmed crime of the suspect and include the crime within the portion of the incident information to release.

At block 615, the second electronic processor 305 receives, from the analytical machine learning model 325, a risk analysis that indicates an impact of releasing the portion of the incident information. The result of the risk analysis may be a textual description describing the impact of releasing the portion of the incident information to the public or not releasing the portion of the incident information to the public. As one example, the result of the risk analysis may be that releasing the portion of the incident information “Will Calm Down The Public.” As another example, the result of the risk analysis may be that not releasing the portion of the incident information “Will Result In Further Questions From The Public.” Accordingly, the risk analysis may assist a public safety officer in determining whether release of the portion of the incident information is helpful.

At block 620, the second electronic processor 305 outputs the portion of the incident information and the impact. For example, the verification and analysis server 105 transmits, using the second network interface 315, the portion of the incident information and the impact generated by the analytical machine learning model 325 to another device over the network 150. The device may be, for example, the communication device 130 associated with a public safety officer.

FIG. 7 illustrates an example method 700 for providing incident information to the public. The method 700 is described as being executed by the communication device 130 and, in particular, by the first electronic processor 205. However, in some instances, the method 700 may be performed by another device (for example, another computer or device within the communication system 100). Additionally, while the process blocks illustrated in FIG. 7 provide one example of a method described herein, it is understood that some blocks may be removed, added, combined, reordered, or modified without departing from the spirit of the present disclosure. The method 700 may occur with respect to a particular public safety incident (e.g., a scene of interest). The public safety incident may be an ongoing public safety incident or a public safety incident selected by a user of the second electronic processor 305. In some implementations, the method 700 is a continuation of the method 600 of FIG. 6.

At block 705, the first electronic processor 205 provides the recommended portion of the incident information. For example, the first electronic processor 205 outputs the portion of the incident information and the impact via the display 220 and/or the speaker 230. In some instances, an electronic digital assistant provides the recommended portion of the incident information and the impact to a user of the communication device 130 automatically upon receiving said incident information from the verification and analysis server 105. In some incidents, the display 220 provides a graphical user interface (GUI) that shows text detailing the recommended portion of the incident information and the impact.

At block 710, the first electronic processor 205 receives, via an input device, an indication as to whether to publish the recommended portion of the incident information. For example, in some instances, the display 220 is a touch-screen display. Alongside the incident information, the display 220 also provides selectable graphical icons. A user may interact with (for example, push) the selectable graphical icons to either release, or not release, the recommended portion of the incident information. In another example, a user of the communication device 130 provides a verbal response detected by the microphone 225 indicating whether to release the recommended portion of the incident information. In yet another example, the user of the communication device 130 interacts with an electronic digital assistant by providing a response (for example, a verbal response) for the electronic digital assistant to perform operations to release, or not release, the recommended portion of the incident information.

At block 715, the first electronic processor 205 outputs, in response to the indication to release the recommended portion of the incident information, the portion of the incident information to public devices. For example, the first electronic processor 205 transmits a notification to the verification and analysis server 105 to release the recommended portion of the incident information. The verification and analysis server 105 transmits a message to devices connected over the network 150 that includes the recommended portion of the incident information. The incident information may be provided via public devices, for example the mobile device 125, via a text message, a push notification, or the like.

In some instances, the verification and analysis server 105 releases the incident information by generating and posting a post on social media (for example, by transmitting a command to the social media server 110). In other instances, the verification and analysis server 105 releases the incident information to news outlets. In another instance, the verification and analysis server 105 releases the incident information by replying to one or more social media posts associated with the public safety incident (for example, one or more social media posts identified by the verification and analysis server as including false information regarding the public safety incident). In this manner, important information is parsed by public safety officers before being released for public consumption.

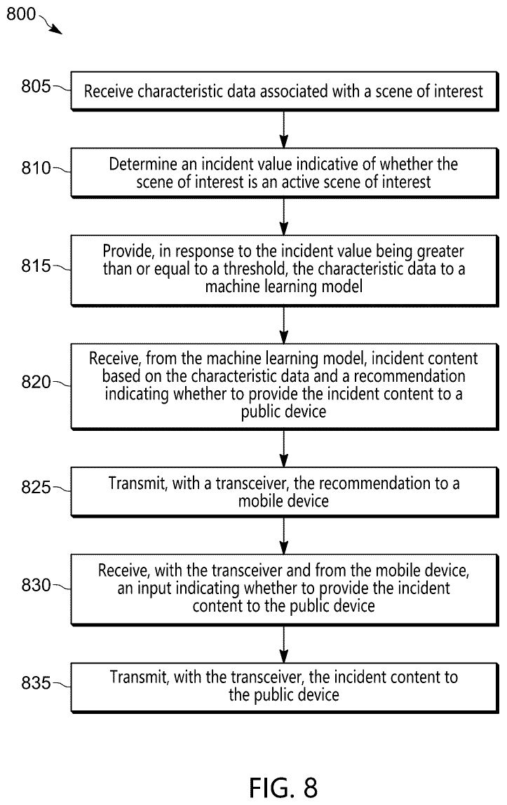

FIG. 8 illustrates an example method 800 for determining whether to release information associated with a public safety incident. The method 800 is described as being executed by the server 105 and, in particular, by the second electronic processor 305. However, in some instances, the method 800 may be performed by another device (for example, another computer or device within the communication system 100) or in conjunction with another device (for example, the communication device 130). Additionally, while the process blocks illustrated in FIG. 8 provide one example of a method described herein, it is understood that some blocks may be removed, added, combined, reordered, or modified without departing from the spirit of the present disclosure. The method 800 may occur with respect to a particular public safety incident (e.g., a scene of interest). The public safety incident may be an ongoing public safety incident or a public safety incident selected by a user of the communication device 130.

At block 805, the second electronic processor 305 receives characteristic data associated with a scene of interest. For example, the second electronic processor 305 receives CAD data, camera feeds, and social media information, as previously described.

At block 810, the second electronic processor 305 determines an incident value indicative of whether the scene of interest is an active scene of interest. For example, the CAD data may indicate whether the public safety incident is an active (e.g., ongoing) public safety incident, and/or may indicate a period of time (e.g., a time frame, a date, a time, etc.) during which the public safety incident was an active public safety incident. In some instances, the second electronic processor 305 determines whether the scene of interest is associated with an incident stored within the dispatch server 115 to determine whether the scene of interest is an active scene of interest. The second electronic processor 305 then sets an incident value based on whether the scene of interest is an active scene of interest, as previously described with respect to FIG. 5.

At block 815, the second electronic processor 305 provides, in response to the incident value being greater than or equal to a threshold, the characteristic data to the analytical machine learning model 325. For example, in response to the incident value being “1”, the second electronic processor 305 provides the received characteristic data to the analytical machine learning model 325.

At block 820, the second electronic processor 305 receives, from the analytical machine learning model 325, incident content based on the characteristic data and a recommendation indicating whether to provide the incident content to a public device. For example, the analytical machine learning model 325 provides, to the second electronic processor 305, a portion of incident information and an impact risk.

At block 825, the second electronic processor 305 transmits, with the second network interface 315, the recommendation to the communication device 130.

At block 830, the second electronic processor 305 receives, with the second network interface 315 and from the communication device 130, an input indicating whether to provide the incident content to the public device. For example, the second electronic processor 305 receives an indication to transmit the incident content to the mobile device 125.

At block 835, the second electronic processor 305 transmits, with the second network interface 315, the incident content to the mobile device 125.

In some instances, the verification machine learning model 320 and/or the analytical machine learning model 325 is trained based on whether the generated incident content is released to the public device. For example, with respect to FIG. 7, after receiving the indication as to whether to publish the recommended portion of the incident information, the second electronic processor 305 updates the analytical machine learning model 325 based on the indication. Accordingly, the analytical machine learning model 325 may continue to be trained.

### Example Use Case

A fire occurs in an apartment building. Several public safety officials are located at the public safety incident (e.g., the fire), and the building has been evacuated. During the public safety incident, the verification and analysis server 105 receives video feeds from security cameras within and near the apartment building, as well as video feeds from body-worn cameras associated with the public safety officials. An incident case file has been opened in the dispatch server 115 and is provided to the verification and analysis server 105. Additionally, members of the public are posting videos and text on social media platforms, which are obtained by the verification and analysis server 105.

The verification and analysis server 105 implements the verification machine learning model 320 and determines that the public safety incident is an active public safety incident, a crowd is situated near the apartment building, and many social media posts are relevant to the public safety incident. Accordingly, the verification and analysis server 105 sets the incident value to “1”. Additionally, the verification machine learning model 320 identifies the following summary of social media posts: “The ambulance crew is not prioritizing calls correctly, resulting in slow dispatch to the public safety incident.”

The verification and analysis server 105 provides the output of the verification machine learning model 320 and the obtained characteristics of the public safety incident to the analytical machine learning model 325. The verification and analysis server 105 and/or the

analytical machine learning model 325 identifies that the ambulance is stuck in a traffic jam while en route to the public safety incident, resulting in a delay to arrive at the public safety incident. The analytical machine learning model 325 generates the following recommended content: “Please clarify that an environmental factor has caused delay of the ambulance to the incident scene and will arrive shortly.” The analytical machine learning model 325 also generates the following impact analysis: “Release of the information will calm the public located at the fire. By not releasing, the public may argue that there was no effective preventive plan from public safety officials.”

The verification and analysis server 105 then transmits the recommended content and the impact analysis to a personal device of a public safety official. The public safety official provides an input approving the release of the recommended content, which is then published via social media, news outlets, and the like.

In the foregoing specification, specific examples have been described. However, one of ordinary skill in the art appreciates that various modifications and changes can be made without departing from the scope of the claimed subject matter. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a

processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited

in each claim. Rather, as the following claims reflect, inventive subject matter lies in less than all features of a single disclosed example. Thus, the following claims are hereby incorporated into the Detailed Description, with each claim standing on its own as a separately claimed subject matter.

Additionally, unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations, for example, collectively. To reiterate, those electronic processors and processing may be distributed.

What is claimed is:

1. A system comprising:
a server including an electronic processor, a transceiver, and a memory, the memory storing a machine learning model, wherein the electronic processor is configured to:
receive characteristic data associated with a scene of interest;
determine an incident value indicative of whether the scene of interest is an active scene of interest;
provide, in response to the incident value being greater than or equal to a threshold, the characteristic data to the machine learning model;
receive, from the machine learning model, incident content based on the characteristic data and a recommendation indicating whether to provide the incident content to a public device;
transmit, with the transceiver, the recommendation to a mobile device, wherein the recommendation is provided via an output device of the mobile device;
receive, with the transceiver and from the mobile device, an input indicating whether to provide the incident content to the public device; and
transmit, with the transceiver, the characteristic data to the public device.

2. The system of claim 1, wherein the characteristic data includes an indication of whether the characteristic data is stored within a computer-aided dispatch (CAD) server.

3. The system of claim 1, wherein the characteristic data includes social media posts associated with the scene of interest.

4. The system of claim 3, wherein the machine learning model is configured to:
analyze keywords included within the social media posts associated with the characteristic data; and
generate the incident content based on the keywords included within the social media posts.

5. The system of claim 1, wherein the characteristic data includes a video stream associated with the scene of interest, and wherein, to determine the incident value, the electronic processor is configured to:
determine, based on the video stream, a number of people located at the scene of interest.

6. The system of claim 1, wherein the electronic processor is further configured to:
update the machine learning model based on the input indicating whether to provide the incident content to the public device.

7. The system of claim 1, wherein the output device is a display device having a graphical user interface, and wherein the input indicating whether to provide the incident content to the public device is a touch input received by the graphical user interface.

8. The system of claim 1, wherein the output device is a speaker, and wherein the input indicating whether to provide the incident content to the public device is a verbal input received by a microphone of the mobile device.

9. The system of claim 8, wherein the mobile device includes an electronic digital assistant, wherein the electronic digital assistant provides the recommendation via the speaker, and wherein the electronic digital assistant receives the verbal input via the microphone.

10. The system of claim 1, wherein the recommendation indicating whether to provide the incident content to a public device includes an impact notification indicating an impact of whether the incident content is released to the public device.

11. The system of claim 1, wherein, to determine the incident value indicating whether the scene of interest is the active scene of interest, the electronic processor is configured to determine whether the scene of interest is associated with a predetermined period of time.

12. A method for releasing incident information, the method comprising:
receiving characteristic data associated with a scene of interest;
determining an incident value indicative of whether the scene of interest is an active scene of interest;
providing, in response to the incident value being greater than or equal to a threshold, the characteristic data to a machine learning model;
receiving, from the machine learning model, incident content based on the characteristic data and a recommendation indicating whether to provide the incident content to a public device;
transmitting, with a transceiver, the recommendation to a mobile device, wherein the recommendation is provided via an output device of the mobile device;
receiving, with the transceiver and from the mobile device, an input indicating whether to provide the incident content to the public device; and
transmitting, with the transceiver, the characteristic data to the public device.

13. The method of claim 12, wherein the characteristic data includes an indication of whether the characteristic data is stored within a computer-aided dispatch (CAD) server.

14. The method of claim 12, wherein the characteristic data includes social media posts associated with the scene of interest.

15. The method of claim 14, further comprising:
analyzing, with the machine learning model, keywords included within the social media posts associated with the characteristic data; and
generating, with the machine learning model, the incident content based on the keywords included within the social media posts.

16. The method of claim 12, wherein the characteristic data includes a video stream associated with the scene of interest, and wherein determining the incident value includes determining, based on the video stream, a number of people located at the scene of interest.

17. The method of claim 12, further comprising:
updating the machine learning model based on the input indicating whether to provide the incident content to the public device.

18. The method of claim 12, wherein the output device is a display device having a graphical user interface, and wherein the input indicating whether to provide the incident content to the public device is a touch input received by the graphical user interface.

19. The method of claim 12, wherein the output device is a speaker, and wherein the input indicating whether to provide the incident content to the public device is a verbal input received by a microphone of the mobile device.

20. The method of claim 19, wherein the mobile device includes an electronic digital assistant, wherein the electronic digital assistant provides the recommendation via the speaker, and wherein the electronic digital assistant receives the verbal input via the microphone.
